(19) United States
(12) Patent Application Publication
(10) Pub. No.: US 2004/0217692 A1
(43) Pub. Date: Nov. 4, 2004

(54) Light emitting device having fluorescent multilayer

(76) Inventors: Jae-hee Cho, Yongin-si (KR); Moon-sook Jeoung, Seoul (KR); Dae-soo Jeong, Yongin-si (KR)

Correspondence Address: LEE & STERBA, P.C., 1101 WILSON BOULEVARD, SUITE 2000, ARLINGTON, VA, 22209, US

(21) Appl. No.: 10/833,053

(22) Filed: Apr. 28, 2004

(30) Foreign Application Priority Data
Apr. 30, 2003 (KR) 2003-27546

(51) Int. Cl. H05B 33/14; H05B 33/00; H05B 33/10

(52) U.S. Cl. 313/503; 313/502; 257/98; 445/24

(57) ABSTRACT

A light-emitting device includes a light source outputting an excitation light and a fluorescent multilayer having at least two fluorescent layers emitting different wavelengths in response to the excitation light. A fluorescent layer emitting a longer wavelength and/or having a lower light conversion efficiency than other fluorescent layers is adjacent to the light source. A fluorescent layer emitting a shorter wavelength and/or having a higher light conversion efficiency than other fluorescent layers, is farthest from the light source. Accordingly, it is possible to increase the overall light conversion efficiency of the light-emitting device and the amount of light output from the light-emitting device.

### BACKGROUND OF THE INVENTION

1. Field of the Invention

The present invention relates to a light-emitting device. More particularly, the present invention is directed to a light-emitting device having a fluorescent multilayer providing high conversion efficiency at multiple wavelengths.

2. Description of the Related Art

A light emitting diode (LED) device emits white light or multiple wavelengths of visible light. To generate this light, the LED converts ultraviolet (UV) light or blue light emitted from an LED chip serving as excitation light into light with wavelengths longer than the excitation light. For example, UV light supplied to a white light LED device excites fluorescent materials therein, which, in turn, emit visible light of three primary colors, i.e., red (R), green (G), and blue (B), to output white light. Different visible wavelengths may be emitted from the fluorescent materials depending on the composition of the fluorescent materials and the wavelength of the excitation light. A human will view an appropriate combination of visible wavelengths as white light.

LED devices have various constructions, from a lead-type LED device to a surface-mount device (SMD)-type LED device. LED devices, and SMD LED devices in particular, can be easily mounted on a large-sized substrate with high integration density. Accordingly, such LED devices have been widely adopted in many different fields, such as backlighting devices, electric illumination devices, e.g., florescent lamps, or other signal devices, and their range of application is expected to become much wider.

FIGS. 1 through 3 illustrate cross-sections of three different conventional LED devices. FIG. 1 illustrates a conventional lead-type LED device 10. FIG. 2 illustrates a conventional SMD-type LED device 20. FIG. 3 illustrates a conventional reflective LED 30 to be used in a lead-type LED device.

Referring to FIG. 1, the conventional lead-type LED device 10 includes a mount lead 11, an inner lead 12, and an LED chip 13. The LED chip 13 is installed inside a cup 11a formed on the mount lead 11. An n-electrode and a p-electrode of the LED chip 13 are electrically connected to the mount lead 11 and the inner lead 12, respectively, via a wire 14. A fluorescent layer 15 covers the LED chip 13. The fluorescent layer 15 is a mixture of a coating resin and fluorescent materials. A transparent resin 16 surrounds part of the mount lead 11, part of the inner lead 12, the cup 11a, the LED chip 13, the wire 14, and the fluorescent layer 15.

Referring to FIG. 2, in the conventional SMD-type LED device 20, an LED chip 23 is installed in a groove of a casing 21. A fluorescent layer 25 covers the LED chip 23 by filling the groove of the casing 21 with a mixture of a coating resin and fluorescent materials. A wire 24 connects an n-electrode and a p-electrode of the LED chip 23 to a conductive wire 22.

Referring to FIG. 3, in the conventional reflectance LED 30, an LED chip 31 is installed in a header 32 having a cup shape. A mirror 33, which is installed at an inner wall of the header 32, reflects light emitted from the LED chip 31. The header 32 is filled with a transparent material 35 having fluorescent materials 34 scattered throughout so that the transparent material 35 surrounds the LED chip 31. A plate glass 36, which is placed over the header 32, prevents light that has not yet been absorbed into the fluorescent materials 34 from being output from the LED 30. A short wave pass (SWP) filter 37 on the LED chip 31 transmits light with a shorter wavelength more efficiently than light with a longer wavelength. This conventional reflectance LED 30 may be used with lead interconnects to form another conventional lead-type LED device.

In such conventional LED devices, UV or blue light serving as the excitation light excites fluorescent materials in a fluorescent layer. The excited fluorescent materials emit visible light, i.e., light having a longer wavelength than that of the excitation light. For example, in an LED device that emits white light using a UV LED chip, the fluorescent layer may include three different types of fluorescent materials, which respectively emit red, green, and blue light when excited by UV light, interspersed therein, or two different types of fluorescent materials, which respectively emit yellow and blue light when excited by UV light, interspersed therein. Alternatively, in an LED device that emits white light using a blue LED chip, the fluorescent layer may include two different types of fluorescent materials, which respectively emit red and green light when excited by blue light, interspersed therein.

A useful measure of performance of light-emitting devices is light conversion efficiency, which is the ratio of the output power to the input power, which is also equivalent to the ratio of intensity. FIG. 4 is a graph illustrating light conversion efficiencies of three different conventional fluorescent materials A, B, and C when excited by UV light generated with a current of 20 mA. Referring to FIG. 4, the fluorescent materials A, B, and C have a high light conversion efficiency, e.g., about 60%, when emitting blue light, e.g., with a wavelength of about 450 nm. The fluorescent materials A, B, and C also have a relatively high light conversion efficiency, e.g., about 40%, when emitting green light, e.g., with a wavelength of about 520 nm. However, when emitting red light, e.g., with a wavelength of about 620 nm, the fluorescent materials A, B, and C have a low light conversion efficiency, e.g., about 15% or less.

Such low light conversion efficiency of the fluorescent materials A, B and C when emitting red light impairs the overall light conversion efficiency of an LED device so significantly that strenuous efforts are currently being made to develop an LED device having a higher light conversion efficiency.

### SUMMARY OF THE INVENTION

The present invention is therefore directed to a light-emitting device, which substantially overcomes one or more of the problems due to the limitations and disadvantages of the related art.

It is therefore a feature of an embodiment of the present invention to provide a light-emitting device having a fluorescent multilayer realizing a high light conversion efficiency.

At least one of the above and other features may be realized by providing a light emitting device including a light source for emitting an excitation light and a fluorescent multilayer having a first fluorescent layer for emitting a first wavelength in response to the excitation light and a second fluorescent layer for emitting a second wavelength in response to the excitation light. The first wavelength is longer than the second wavelength, and the first fluorescent layer is closer to the light source than the second fluorescent layer.

The excitation light may be UV light or blue light. The light source may be a light emitting diode (LED) chip.

The light emitting the fluorescent multilayer may include a third fluorescent layer, farther from the light source than the second fluorescent layer. The first fluorescent layer may be adjacent to the light source and may emit red light, e.g., having a wavelength of 580 nm˜700 nm. The second fluorescent layer may be adjacent to the first fluorescent layer and may emit green light, e.g., having a wavelength of 500 nm˜550 nm. The third fluorescent layer may be adjacent to the second fluorescent layer and may emit blue light, e.g., having a wavelength of 420 nm˜480 nm. The second fluorescent layer may be adjacent to the first fluorescent layer and may emit both green light, e.g., having a wavelength of 500 nm˜550 nm, and blue light, e.g., having a wavelength of 420 nm˜480 nm. The first fluorescent layer may emit yellow light, e.g., having a wavelength of 560 nm˜580 nm and the second fluorescent layer may emit blue light having a wavelength of 420 nm˜480 nm. The second fluorescent layer may emit yellow light, e.g., having a wavelength of 560 nm˜580 nm.

At least one of the above and other features may be realized by providing a light emitting device including a light source for emitting excitation light and a fluorescent multilayer having a first fluorescent layer for emitting a first wavelength at a first light conversion efficiency in response to the excitation light and a second fluorescent layer for emitting a second wavelength at a second light conversion efficiency in response to the excitation light. The first wavelength is different than the second wavelength, the first light conversion efficiency is lower than the second light conversion efficiency, and the first fluorescent layer is closer to the light source than the second fluorescent layer.

The excitation light may be UV light or blue light. The light source may be a light emitting diode (LED) chip. The first wavelength may be longer than the second wavelength.

At least one of the above and other features may be realized by providing a method of forming a light emitting device including providing a first fluorescent layer on a light source for outputting excitation light, the first fluorescent layer for emitting light having a first wavelength in response to the excitation light at a first light conversion efficiency; and providing a second fluorescent layer on the first fluorescent layer, the second fluorescent layer for emitting light having a second wavelength in response to the excitation light at a second light conversion efficiency. The first wavelength is different than the second wavelength and the first efficiency is lower than the second efficiency. The first wavelength may be longer than the second wavelength.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIGS. 1 through 3 illustrate cross-sections of three different conventional light emitting diode (LED) devices;

FIG. 4 is a graph illustrating light conversion efficiencies of three different conventional fluorescent materials that emit red, green, and blue light;

FIGS. 5A and 5B illustrate cross-sections of a lead-type LED device according to a first embodiment of the present invention and a SMD-type LED device according to a second embodiment of the present invention, respectively;

FIG. 6 illustrates a cross-section of an LED device according to a third embodiment of the present invention;

FIG. 7 illustrates a cross-section of an LED device according to a fourth embodiment of the present invention;

FIG. 8 illustrates a cross-section of an LED device according to a fifth embodiment of the present invention;

FIG. 9 is a diagram comparing the light conversion efficiency of the LED device according to the third embodiment of the present invention with that of a conventional LED device; and

FIG. 10 is a diagram comparing the light conversion efficiency of the LED device according to the fourth embodiment of the present invention with that of a conventional LED device.

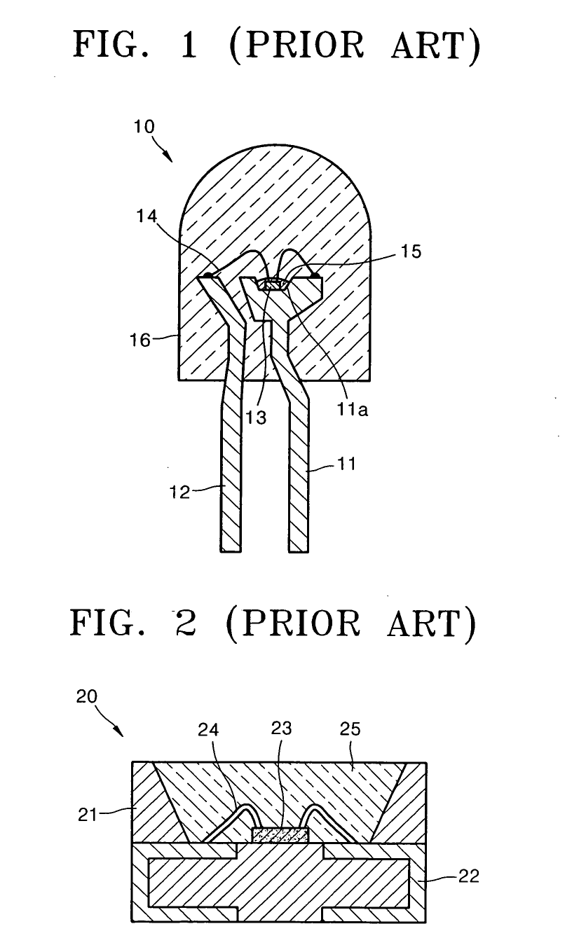

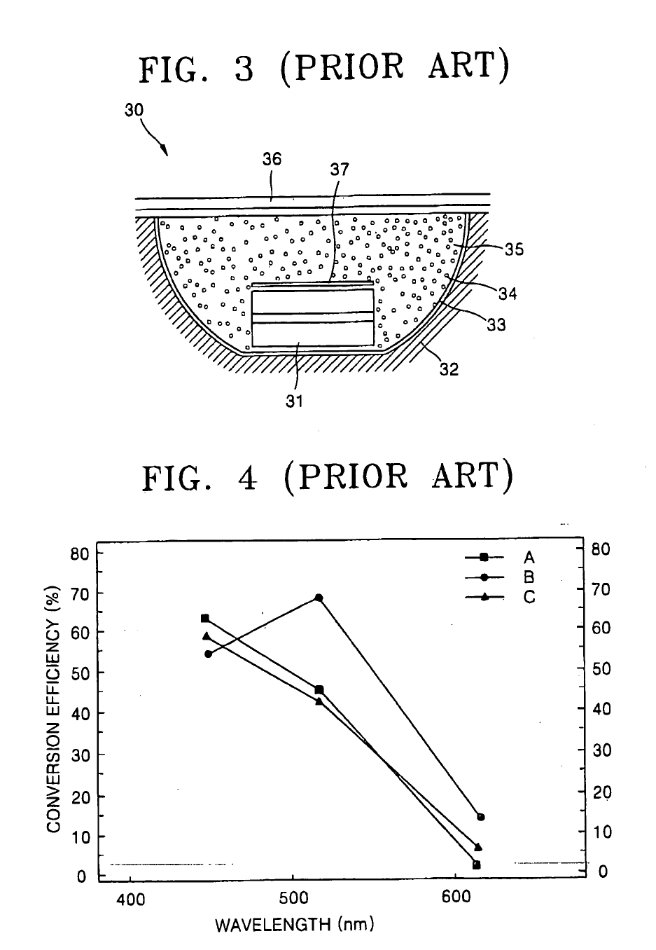

### DETAILED DESCRIPTION OF THE INVENTION

Korean Patent Application No. 2003-27546, filed on Apr. 30, 2003, in the Korean Intellectual Property Office, and entitled “Light Emitting Diode device Having Fluorescent Multilayer,” is incorporated by reference herein in its entirety.

Hereinafter, the present invention will be described more fully with reference to the accompanying drawings in which exemplary embodiments of the invention are shown. The invention may, however, be embodied in many different forms and should not be construed as being limited to the embodiments set forth herein. Rather, these embodiments are provided so that this disclosure will be thorough and complete, and will convey the concept of the invention to those skilled in the art. In the drawings, the thicknesses of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. In different drawings, the same reference numerals represent the same elements.

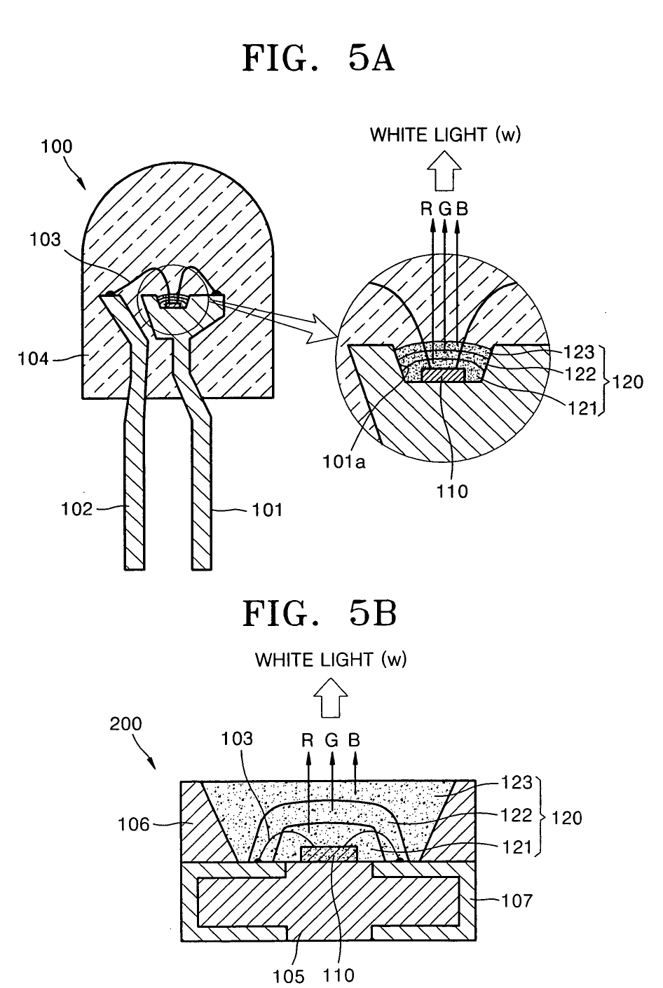

FIGS. 5A and 5B illustrate cross-sections of a lead-type LED device 100 according to a first embodiment of the present invention and a SMD-type LED device 200 according to a second embodiment of the present invention, respectively.

Referring to FIG. 5A, the lead-type LED device 100 includes a mount lead 101, an inner lead 102, and an LED chip 110 inside a cup 101a formed on the mount lead 101. An n-electrode and a p-electrode of the LED chip 110 are electrically connected to the mount lead 101 and the inner lead 102, respectively, via a wire 103. A transparent resin 104, such as an epoxy resin, may surround the mount lead 101, the inner lead 102, the wire 103, the cup 101a, and the LED chip 110.

The LED chip 110 generates ultraviolet (UV) light having a wavelength of about 410 nm or shorter. In the present embodiment, the UV light excites fluorescent materials contained in the fluorescent multilayer 120.

The fluorescent multilayer 120 may include three fluorescent layers 121 through 123 formed of three different fluorescent materials. These different fluorescent materials emit light of different wavelengths in response to the excitation.

Referring to FIG. 5B, in the SMD-type LED device 200, the LED chip 110, which emits UV light, is installed in a casing 106 formed on a substrate 105. The fluorescent multilayer 120 is provided in a groove of the casing 106. Again, the fluorescent multilayer 120 includes three fluorescent layers respectively formed of three different fluorescent materials, i.e., first, second and third fluorescent layers 121, 122, and 123. The wire 103 electrically connects the n-electrode and the p-electrode of the LED chip 110 to a conducting wire 107 on the substrate 105.

As shown in FIGS. 5A and 5B, the LED devices 100 and 200 according to the first and second embodiments, respectively, of the present invention both include a fluorescent multilayer 120 formed on an LED chip 110. The fluorescent multilayer 120 may include first through third fluorescent layers 121 through 123. The first through third fluorescent layers 121 through 123 contain different fluorescent materials that emit light having different wavelengths when excited by UV light.

In the particular example illustrated in FIGS. 5A and 5B, the LED devices 100, 200 are shown as white (W) light devices. Such white light may be realized by outputting red (R), green (G) and blue (B) light from the different fluorescent layers 121 through 123.

More specifically, the first fluorescent layer 121 is formed on the UV LED chip 110 and may be a mixture of epoxy resin, silicon resin and a first fluorescent material that emits red light (R). The first fluorescent layer 121 may be formed of a first fluorescent material that emits light having a wavelength of 580 nm˜700 nm, more specifically, 600 nm˜650 nm, when excited by UV light. For example, SrS:Eu²⁺, Y₂O₂S:Eu, YVO:Eu, or M(WO):Eu,SM(M;Li, Na, K, Ba, Ca, or Mg) could be used as the first fluorescent material.

The second fluorescent layer 122 is formed on the first fluorescent layer 121 and may be a mixture of epoxy resin, silicon resin and a second fluorescent material that emits green light (G). The second fluorescent layer 122 may be formed of a second fluorescent material that emits light having a wavelength of 500 nm˜550 nm when excited by UV light. For example, TG(SrGa₂S₄:Eu²⁺) or (BaSr)SiO:EuM(M;Ho, Er, Ce or Y) could be used as the second fluorescent material.

The third fluorescent layer 123 is deposited on the second fluorescent layer 122 and is formed of a mixture of epoxy resin, silicon resin and a third fluorescent material that emits blue light (B). The third fluorescent layer 123 may be formed of a third fluorescent material that emits light having a wavelength of 420 nm˜480 nm when excited by UV light. For example, Ca₁₀(PO₄)₆Cl₂:Eu²⁺ or Sr₅:(PO₄)₃Cl:Eu could be used as the third fluorescent material.

In the LED devices 100 and 200 according to the first and second embodiments, respectively, of the present invention, UV light emitted from the LED chip 110 excites the three different fluorescent materials contained in the first through third fluorescent layers 121 through 123. Accordingly, R, G, and B light are emitted from the first, second, and third fluorescent layers 121,122, and 123, respectively. A human will perceive a combination of the R, G, and B light, emitted from the first, second, and third fluorescent layers 121, 122, and 123, respectively, as white light (W).

In the first and second embodiments of the present invention, the fluorescent multilayer 120 is formed of multiple layers, i.e., a three layers.

More specifically, the first fluorescent layer 121 that emits red light is deposited on the LED chip 110, and the second and third fluorescent layers 122 and 123 that emit green light and blue light, respectively, are sequentially deposited on the first fluorescent layer 121. By placing the first fluorescent layer 121 that emits red light, for which a lowest light conversion efficiency is obtained, at a position closest to the LED chip 110, the light conversion efficiency of the first fluorescent layer 121 can become relatively higher. Thus, the light conversion efficiency of the overall LED device 100 or 200 can be enhanced.

If the third, second, and first fluorescent layers 123, 122, and 121 are sequentially deposited on the LED chip 110 so that the third fluorescent layer 123 that emits blue light with a shortest wavelength can be placed at the position closest to the LED chip 110 and the first fluorescent layer 121 can be placed at a position farthest away from the LED chip 110, UV light emitted from the LED chip 110 is absorbed into the third and second fluorescent layers 123 and 122 before the UV light reaches the first fluorescent layer 121. Thus, the light conversion efficiency of the first fluorescent layer 121 becomes much lower.

Therefore, in the present invention, the first, second, and third fluorescent layers 121, 122, and 123 are sequentially deposited on the LED chip 110 so that the first fluorescent layer 121 may be placed at the position closest to the LED chip 110, the third fluorescent layer 123 may be placed at the position farthest away from the LED chip 110, and the second fluorescent layer 122 may be placed between the first and third fluorescent layers 121 and 123. This relative placement is dictated by the relative efficiencies of the fluorescent layers, with the least efficient being the closest to the excitation light source, and the most efficient being farthest from the excitation light source.

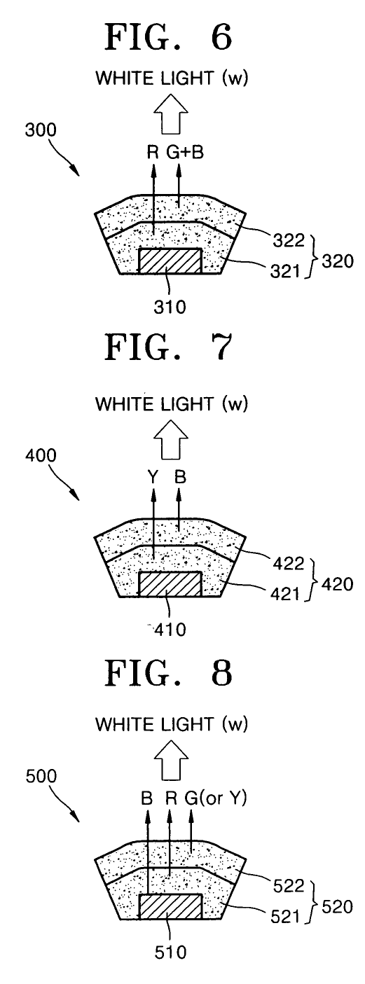

FIGS. 6 through 8 illustrate cross-sections of LED devices according to third through fifth embodiments of the present invention. FIGS. 6 through 8 illustrate only distinctive features of the LED/fluorescent multilayer aspects of the LED devices 300, 400, and 500 according to third, fourth, and fifth embodiments, respectively. In other words, only that portion of the LED devices differing from the LED devices 100 and 200 according to the first and second embodiments, respectively, of the present invention, shown in FIGS. 5A and 5B, respectively will be discussed in detail below. It is to be understood that the LED devices 300, 400, and 500 may be realized as either lead-type or SMD-type devices, as discussed above regarding the first and second embodiments, respectively.

Referring to FIG. 6, the LED device 300 includes an LED chip 310 and a fluorescent multilayer 320 covering the LED chip 310. In the present embodiment, the fluorescent multilayer 320 includes two layers, i.e., a first fluorescent layer 321 and a second fluorescent layer 322. The LED chip 310 emits UV light with a wavelength of 410 nm or shorter as excitation light.

More specifically, the first fluorescent layer 321 on the LED chip 310 may be a mixture of epoxy resin, silicon resin and a fluorescent material that emits red light (R). Examples of such fluorescent materials, and the wavelength range of red light emitted from such fluorescent materials, have already been described above. Thus, the details thereof will not be repeated here.

The second fluorescent layer 322, on the first fluorescent layer 321, may be formed of a mixture of epoxy resin, silicon resin and two different fluorescent materials that emit green light (G) and blue light (B), respectively. Examples of fluorescent materials that respectively emit green light (G) and blue light (B), and the wavelength ranges of light respectively emitted from such fluorescent materials, have already been described above.

In the LED device 300, UV light emitted from the LED chip 310 excites the fluorescent material of the first fluorescent layer 321 and the fluorescent materials of the second fluorescent layer 322. As a result, red light (R) is emitted from the first fluorescent layer 321, and green light (G) and blue light (B) are emitted from the second fluorescent layer 322. A human sees a combination of the R, G, and B light emitted from the fluorescent multilayer 320 as white light (W).

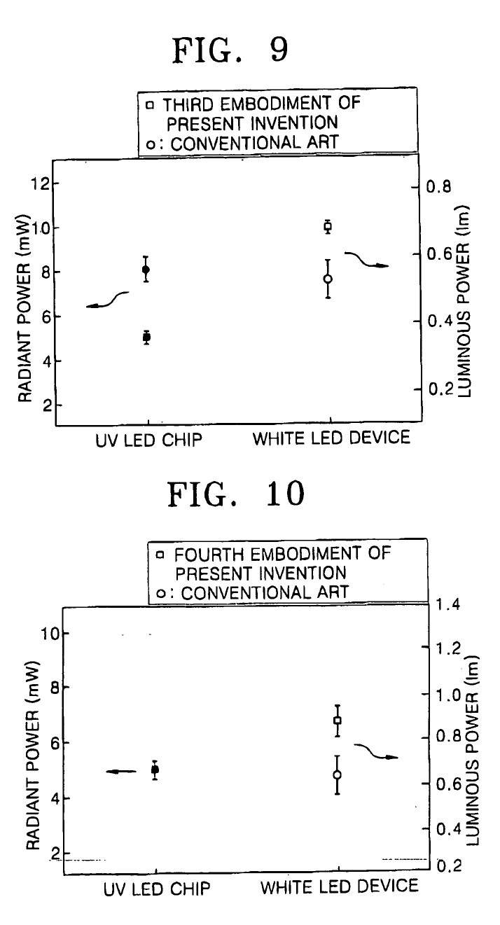

As described above, in the third embodiment of the present invention, the fluorescent layer 320 includes two layers to convert UV light into visible light such that the first fluorescent layer 321, from which light of a longest wavelength, i.e., red light (R), is emitted, is deposited on the LED chip 310, and the second fluorescent layer, from which light having shorter wavelengths, i.e., green light and blue light, is emitted, is deposited on the first fluorescent layer 321. Therefore, in the present embodiment, like in the previous embodiments, light conversion efficiency can be enhanced, which will become more apparent from the comparison shown in FIG. 9.

Referring to FIG. 7, the LED device 400 includes an LED chip 410 and a fluorescent multilayer 420 covering the LED chip 410. In the fourth embodiment of the present invention, like in the third embodiment of the present invention, the fluorescent multilayer 420 includes two layers, i.e., a first fluorescent layers 421 and a second fluorescent layer 422. The LED chip 410 emits UV light having a wavelength of 410 nm or shorter as excitation light.

More specifically, the first fluorescent layer 421 formed on the LED chip 410 may be a mixture of epoxy resin, silicon resin and a fluorescent material that emits yellow light (Y). The fluorescent material emits light having a wavelength of 560 nm˜580 nm when excited by UV light. For example, yttrium aluminium garnet (YAG) could be used as the fluorescent material.

The second fluorescent layer 422 formed on the first fluorescent layer 421 may be a mixture of epoxy resin, silicon resin, and a fluorescent material that emits blue light (B). Examples of fluorescent materials, and the wavelength range of blue light (B) emitted from such fluorescent materials, have already been described above in previous embodiments, and will not be repeated here.

In the LED device 400, UV light from the LED chip 410 excites the fluorescent material of the first fluorescent layer 421 and the fluorescent material of the second fluorescent layer 422. As a result, yellow light (Y) is emitted from the first fluorescent layer 421, and blue light (B) is emitted from the second fluorescent layer 422. A human will view a combination of the Y and B light emitted from the fluorescent multilayer 420 as white light (W).

As described above, in the fourth embodiment of the present invention, the fluorescent layer 420 includes two layers to convert UV light into visible light such that the first fluorescent layer 421, from which light of a longest wavelength, i.e., yellow light (Y), is emitted, is deposited on the LED chip 410, and the second fluorescent layer, from which light of a shorter wavelength, i.e., blue light (B), is emitted, is deposited on the first fluorescent layer 421. Therefore, in the present embodiment, like in the previous embodiments, light conversion efficiency can be generally enhanced.

Referring to FIG. 8, the LED device 500 includes an LED chip 510 and a fluorescent multilayer 520 covering the LED chip 510. The LED chip 510 emits blue light (B) of a wavelength of 420 nm˜480 nm as excitation light. The fluorescent multilayer 520 includes two layers, i.e., a first fluorescent layers 521 and a second fluorescent layer 522.

More specifically, the first fluorescent layer 521 may be a mixture of epoxy resin, silicon resin and a fluorescent material that emits red light (R).

Examples of fluorescent materials that emit red light (R), and the wavelength range of light emitted from such fluorescent materials, have already been described above, and are similarly useful when the excitation light is blue light rather than UV light.

The second fluorescent layer 522, which is on the first fluorescent layer 521, may be a mixture of epoxy resin, silicon resin and a fluorescent material that emits green light (G) or yellow light (Y). Examples of fluorescent materials that emit green light (G) or yellow light (Y), and the wavelength range of light emitted from such fluorescent materials, have already been described above, and are similarly useful when the excitation light is blue light rather than UV light.

In the LED device 500, blue light (B) emitted from the LED chip 510 excites the fluorescent material of the first fluorescent layer 521 such that red light (R) is emitted from the first fluorescent layer 521. In addition, the blue light (B) also excites the fluorescent material of the second fluorescent material 522 such that green light (G) or yellow light (Y) is emitted from the second fluorescent layer 522. A human will view a combination of the red light (R) and the green light (G) (or the yellow light (Y)), emitted from the fluorescent multilayer 520, and the blue light (B), emitted from the LED chip 510, as white light (W).

As described above, in the fifth embodiment of the present invention, the fluorescent multilayer 520 is formed of a double layer to convert blue light into visible light such that the first fluorescent layer 521, from which light of a longest wavelength, i.e., red light (R), is emitted, is deposited on the LED chip 510, and the second fluorescent layer 522, from which light of a shorter wavelength, i.e., green light (G) or yellow light (Y), is emitted, is deposited on the first fluorescent layer 521. Therefore, in the present embodiment, like in the previous embodiments, light conversion efficiency can be generally enhanced.

Experimental results showing the performance of the LED devices 300 and 400 according to the third and fourth embodiments, respectively, of the present invention will now be presented.

FIG. 9 is a diagram comparing the light conversion efficiency of the LED device 300 of FIG. 6 with that of a conventional LED device. FIG. 10 is a diagram comparing the light conversion efficiency of the LED device 400 of FIG. 7 with that of a conventional LED device. In both of these diagrams, a circle corresponds to the conventional art and a square corresponds to an embodiment of the present invention. The arrows indicate the appropriate axis for the respective quantities.

For the comparison shown in FIG. 9, an LED device configured as the LED device 300 of the third embodiment of the present invention, as shown in FIG. 6, and a conventional LED device including a single fluorescent layer having a mixture of fluorescent materials that respectively emit red light (R), green light (G), and blue light (B) were used. In addition, an LED chip that emits UV light at a power having a radiant power of about 5 mW was used in the LED device of the third embodiment of the present invention, and an LED chip that emits UV light having a radiant power of about 8 mW was used in the conventional LED chip.

As can be seen in FIG. 9, the LED device of the third embodiment of the present invention outputs white light having an average luminous power of 0.68 Im (2.3 mW) when excited with UV light having a radiant power of about 5 mW, while the conventional LED device outputs white light having an average luminous power of 0.53 Im (2.1 mW) when excited with UV light having a radiant power of about 8 mW. Thus, the light conversion efficiency of the LED device 300 according to the third embodiment of the present invention is about 46%, which is much higher than the light conversion efficiency of about 26% of the conventional LED device.

For the comparison of FIG. 10, an LED device configured as the LED device 400 of the fourth embodiment of the present invention, as shown in FIG. 7, and an LED device including a single fluorescent layer having a mixture of fluorescent materials that respectively emit yellow light (Y) and blue light (B) were used as examples of the present invention and the conventional art, respectively. In addition, LED chips that emit UV light having a radiant power of about 5 mW were used in both the LED device of the fourth embodiment of the present invention and the conventional LED chip.

As can be seen in FIG. 10, the LED device of the fourth embodiment of the present invention outputs white light having an average luminous power of 0.884 Im (3.15 mW) when excited by UV light having a radiant power of about 5 mW, while the conventional LED device outputs white light having an average luminous power of 0.649 Im (2.16 mW) when excited by UV light having a radiant power of about 5 mW. Thus, the light conversion efficiency of the LED device 400 according to the fourth embodiment of the present invention is about 63%, which is much higher than the light conversion efficiency of 43% of the conventional LED device.

The above-described comparisons indicate that the overall light conversion efficiency of an LED device can be enhanced by forming a first fluorescent layer that emits the light of the longest wavelength, here red light (R), and/or has a lowest light conversion efficiency on an LED chip. This positioning maximizes the amount of UV light absorbed by the first fluorescent layer, thus enhancing the light conversion efficiency of the first fluorescent layer. In short, the LED device according to the present invention can provide a higher light conversion efficiency than a conventional LED device.

As described above, in the present invention, a fluorescent multilayer is formed of a first fluorescent layer that emits light of a longest wavelength on an LED chip and fluorescent layers that emit light of a shorter wavelength deposited on the first fluorescent layer. By doing so, the light conversion efficiency of the first fluorescent layer increases. As such, it is possible to increase the overall light conversion efficiency of an LED device and the amount of light output from the LED device.

Of course, the above order of fluorescent layers in the fluorescent multilayer is assuming the light conversion efficiency is inversely proportional to the wavelength of the emitted light, i.e., the shorter the emitted wavelength, the higher the conversion efficiency. If the materials chosen for the fluorescent layers do not follow this assumption, the order of the fluorescent layers is then dictated by the respective efficiencies of the fluorescent layers, with the least efficient being closest to the excitation light source and the most efficient being farthest from the excitation light source.

While the present invention has been particularly shown and described with reference to exemplary embodiments thereof, it will be understood by those of ordinary skill in the art that various changes in form and details may be made therein without departing from the spirit and scope of the present invention as defined by the following claims. For example, the LED device according to the present invention has been described above as emitting white light. However, the present invention is not restricted to the LED device that emits white light. Rather, the LED device according to the present invention could emit visible light of various wavelengths according to the composition of its fluorescent multilayer. One of the most significant features of the present invention is the fluorescent multilayer, and thus, much of this disclosure has been devoted to descriptions of a method of forming the fluorescent multilayer by depositing different fluorescent materials and the order of depositing the fluorescent materials. Thus, the present invention could be applied to any type of light emitting device, including providing a reflective structure under the fluorescent multilayer.

What is claimed is:

1. A light emitting device, comprising:
a light source for emitting an excitation light; and
a fluorescent multilayer having a first fluorescent layer for emitting a first wavelength in response to the excitation light and a second fluorescent layer for emitting a second wavelength in response to the excitation light,
wherein the first wavelength is longer than the second wavelength, and the first fluorescent layer is closer to the light source than the second fluorescent layer.

2. The light emitting device as claimed in claim 1, wherein the excitation light is UV light.

3. The light emitting device as claimed in claim 2, wherein the fluorescent multilayer further comprises a third fluorescent layer, farther from the light source than the second fluorescent layer.

4. The light emitting device as claimed 3, wherein the first fluorescent layer is adjacent to the light source and emits red light, the second fluorescent layer is adjacent to the first fluorescent layer and emits green light, and the third fluorescent layer is adjacent to the second fluorescent layer and emits blue light.

5. The light emitting device as claimed in claim 4, wherein the first fluorescent layer includes a first fluorescent material that emits red light having a wavelength of 580 nm˜700 nm, the second fluorescent layer includes a second fluorescent material that emits green light having a wavelength of 500 nm˜550 nm, and the third fluorescent layer includes a third fluorescent material that emits blue light having a wavelength of 420 nm˜480 nm.

6. The light emitting device as claimed in claim 2, wherein the first fluorescent layer is adjacent to the light source and emits red light, and the second fluorescent layer is adjacent to the first fluorescent layer and emits green light and blue light.

7. The light emitting device as claimed in claim 6, wherein the first fluorescent layer includes a first fluorescent material that emits red light having a wavelength of 580 nm˜700 nm, and the second fluorescent layer includes a second fluorescent material that emits green light having a wavelength of 500 nm˜550 nm and a third fluorescent material that emits blue light having a wavelength of 420 nm˜480 nm.

8. The light emitting device as claimed in claim 2, wherein the first fluorescent layer emits yellow light and the second fluorescent layer emits blue light.

9. The light emitting device as claimed in claim 8, wherein the first fluorescent layer includes a first fluorescent material that emits yellow light having a wavelength of 560 nm˜580 nm, and the second fluorescent layer includes a second fluorescent material that emits blue light having a wavelength of 420 nm˜480 nm.

10. The light emitting device as claimed in claim 1, wherein the excitation light is blue light.

11. The light emitting device as claimed in claim 10, wherein the first fluorescent layer is adjacent to the light source and emits red light, and the second fluorescent layer is adjacent to the first fluorescent layer and emits green light.

12. The light emitting device as claimed in claim 11, wherein the first fluorescent layer includes a first fluorescent material that emits red light having a wavelength of 580 nm˜700 nm, and the second fluorescent layer includes a second fluorescent material that emits green light having a wavelength of 500 nm˜550 nm.

13. The light emitting device as claimed in claim 10, wherein the first fluorescent layer is adjacent to the light source and emits red light, and the second fluorescent layer is adjacent to the first fluorescent layer and emits yellow light.

14. The light emitting device as claimed in claim 12, wherein the first fluorescent layer includes a first fluorescent material that emits red light having a wavelength of 580 nm˜700 nm, and the second fluorescent layer includes a fluorescent material that emits yellow light having a wavelength of 560 nm˜580 nm.

15. The light emitting device as claimed in 1, wherein the light source is a light emitting diode (LED) chip.

16. A light emitting device, comprising:
a light source for emitting an excitation light; and
a fluorescent multilayer having a first fluorescent layer for emitting a first wavelength at a first light conversion efficiency in response to the excitation light and a second fluorescent layer for emitting a second wavelength at a second light conversion efficiency in response to the excitation light,
wherein the first wavelength is different than the second wavelength, the first light conversion efficiency is lower than the second light conversion efficiency, and the first fluorescent layer is closer to the light source than the second fluorescent layer.

17. The light emitting device as claimed in 16, wherein the light source is a light emitting diode (LED) chip.

18. The light emitting device as claimed in claim 16, wherein the first wavelength is longer than the second wavelength.

19. A method of forming a light emitting device, comprising:
providing a first fluorescent layer on a light source for outputting an excitation light, the first fluorescent layer for emitting light having a first wavelength in response to the excitation light at a first light conversion efficiency; and
providing a second fluorescent layer on the first fluorescent layer, the second fluorescent layer for emitting light having a second wavelength in response to the excitation light at a second light conversion efficiency,
wherein the first wavelength is different than the second wavelength and the first efficiency is lower than the second efficiency.

20. The method as claimed in claim 19, wherein the first wavelength is longer than the second wavelength.
